(19) United States
(12) Patent Application Publication
(10) Pub. No.: US 2013/0049371 A1
(43) Pub. Date: Feb. 28, 2013

(54) OIL SUPPLY IN RENEWABLE ENERGY TURBINE GENERATOR

(71) Applicants: Uwe Stein, Midlothian (GB); Robert Fox, Midlothian (GB); Alasdair Robertson, Midlothian (GB); William Rampen, Midlothian (GB)

(72) Inventors: Uwe Stein, Midlothian (GB); Robert Fox, Midlothian (GB); Alasdair Robertson, Midlothian (GB); William Rampen, Midlothian (GB)

(73) Assignee: MITSUBISHI HEAVY INDUSTRIES, LTD., Minato-ku, Tokyo, (JP)

(21) Appl. No.: 13/390,897

(22) PCT Filed: Aug. 30, 2011
(86) PCT No.: PCT/JP11/04842

§ 371 Date: Apr. 19, 2012

(51) Int. Cl. F03D 11/02

(52) U.S. Cl. 290/55

(57) ABSTRACT

A renewable energy turbine generator (1), such as a wind turbine generator, comprises a hydraulic pump (20), a hydraulic motor (24) and an oil circuit (26, 28) connecting the hydraulic pump and the hydraulic motor. Oil in the low pressure side (28) of the oil circuit is cooled and supplied to the working chambers (95) of the hydraulic pump. A reduced temperature oil feed provides additionally cooled oil to the bearings of the hydraulic pump and the hydraulic motor. Thus, cooler and more viscous oil is supplied to the bearings (84) of the hydraulic pump and/or hydraulic motor and warmer and less viscous oil is supplied to the working chambers, increasing the efficiency and lifetime of the bearings and of the working portions of the hydraulic pump and motor.

### TECHNICAL FIELD

The invention relates to the field of renewable energy turbine generators, such as wind turbine generators (WTGs) or tidal turbine generators. The invention concerns such devices employing a hydraulic transmission including a hydraulic pump driven by a turbine and a hydraulic motor which drives an electricity generator or other load.

### BACKGROUND ART

It is known for the bearings of hydraulic pumps and motors in WTGs (and typically also the gearbox in WTGs having gearboxes) to be fed a supply of oil which has been cleaned and which is relatively cool. The relatively low temperature is important in order to keep up the viscosity of the oil, in order to give the bearings a long lifetime. The cleaning of oil is also important to minimise wear of the hydraulic pumps and motors.

However, it is preferable for the oil which is employed as a working fluid and introduced into the working chambers of the hydraulic pump through a line to have a relatively low viscosity. This increases the energy efficiency of the hydraulic pump and motor.

It has been proposed to employ different oils for the bearings and for the working chambers. However, this requires two seals to be used on each side of the cam, one to retain each of the oils with a void therebetween to allow leaks to drain away, giving a total of four seals. Shaft seals which must provide very good barriers are difficult to engineer if they are to remain reliable for a long period of time and can be difficult to maintain as they are located deep within the pump, or motor respectively.

Accordingly, the invention aims to provide an improved arrangement for supplying relatively high viscosity oil to the bearings of a renewable energy turbine generator pump and motor, and relatively low viscosity oil to the working chambers. Some embodiments of the invention also aim to supply relatively high viscosity oil to the crank case of hydraulic pumps and/or motors to lubricate parts such as piston rollers.

### SUMMARY OF INVENTION

According to a first aspect of the invention there is provided a renewable energy turbine generator comprising:
a rotor, a generator and a hydraulic transmission which transmits rotational energy from the rotor to the generator,
the hydraulic transmission comprising a variable displacement hydraulic pump which is driven by the rotor, a variable displacement hydraulic motor which is coupled to the generator, and an oil circuit comprising a high pressure oil line which is arranged between a discharge side of the hydraulic pump and an intake side of the hydraulic motor, and a low pressure line which is arranged between an intake side of the hydraulic pump and a discharge side of the hydraulic motor,
each of the hydraulic pump and the hydraulic motor comprising: a plurality of working chambers each of which is defined by a cylinder and a piston slidably mounted in the cylinder, a rotatable shaft couple to a cam, the cam having a cam surface in engagement with the said pistons, the cycles of working chamber volume being coupled to rotation of the rotatable shaft, bearings in engagement with the rotatable shaft, and a plurality of valves for regulating the net displacement of working fluid between each working chamber and the high and low pressure lines, at least one valve associated with each working chamber being an electronically controlled valve, said electronically controlled valves being operable by the controller to select the volume of working fluid displaced by each said working chamber on each cycle of working chamber volume and thereby regulate the net rate of displacement of working fluid by the hydraulic pump and the hydraulic motor respectively,
wherein the hydraulic pump and/or the hydraulic motor comprise a reduced temperature oil feed configured to introduce oil to the bearings, wherein the renewable energy turbine generator comprises at least one first temperature regulator for regulating the temperature of oil to the reduced temperature oil feed such that the oil supplied by the reduced temperature oil feed is cooler than the oil supplied from the oil circuit to the working chambers of the hydraulic pump and/or hydraulic motor respectively.

Thus, oil supplied through the reduced temperature oil feeds plays a direct role in lubricating the bearings. The bearings (of the hydraulic pump and/or hydraulic motor respectively) are preferably immersed in oil received from the reduced temperature oil feeds.

Where the hydraulic pump and the hydraulic motor respectively comprise a reduced temperature oil feed, a single first temperature regulator may regulate the temperature of oil provided through the reduced temperature oil feed of each of the hydraulic pump and the hydraulic motor. Alternatively, the hydraulic pump and hydraulic motor may each have a separate first temperature regulator. Typically, the at least one first temperature regulator is a cooler. It may be that either or both of the reduced temperature oil feeds are in fluid communication with the low pressure line.

It may be that the reduced temperature oil feeds are in fluid communication with the oil circuit to receive oil from the oil circuit and to regulate the temperature of the received oil before it is introduced to the bearings.

It may be that the renewable energy turbine generator comprises at least one first filter arranged to filter at least a proportion of oil circulating in the oil circuit and at least one second filter interposed in the reduced temperature oil feeds to filter oil before it is introduced to the bearings, wherein the at least one second filter is finer than the at least one first filter.

In some embodiments, at least one second filter is arranged downstream of the at least one first filter to filter oil some or all of which has passed through at least one first filter since it was last discharged by the hydraulic pump or the hydraulic motor.

It may be that the renewable energy turbine generator further comprises at least one second temperature regulator to regulate the temperature of (typically cool) oil in the oil circuit.

The at least one second temperature regulator may be in thermal communication with oil in the oil circuit. The oil circuit may comprise one or more branches (which receive oil from the oil circuit and reintroduce oil to the oil circuit) and the at least one second temperature regulator may be in thermal communication with at least one said branch. It may be that the or each reduced temperature oil feed is in fluid communication with a said branch, downstream of at least part of one second temperature regulator and thereby directs oil which has already been temperature regulated at least in part by at least one second temperature regulator to at least one first temperature regulator and then to the bearings.

The at least one first temperature regulator may be a refrigerator. The at least one first temperature regulator may be thermostatic. The at least one first temperature regulator may be an oil-water temperature regulator, or an oil-air temperature regulator.

The at least one second temperature regulator may be a refrigerator. The at least one second temperature regulator may be thermostatic. The at least one second temperature regulator may be an oil-water temperature regulator, or an oil-air temperature regulator.

It may be that the second oil receiving inlet is in fluid communication with the first conduit downstream of the first filter. Thus, oil filtered by the second filter may have already been filtered by the first filter.

It may be that the hydraulic pump and/or the hydraulic motor respectively comprise a restrictor (for example, a restrictor ring or other imperfect seal) around the respective rotating shaft which in part defines and retains oil within a volume including the bearings, wherein the reduced temperature oil feed is in fluid communication with the volume including the bearings.

Typically, the restrictor restricts rather than prevents the passage of oil. In this case, as the restrictor does not prevent the passage of oil, oil will gradually pass through or around the restrictor, and in due course mix with oil from the oil circuit. Thus the restrictor typically divides oil from the reduced temperature oil feed from oil from the oil circuit. This is technically simpler, more cost effective and requires less maintenance than providing a perfect shaft seal to retain oil within the bearings. It may be that the restrictor takes the form of a restrictor ring, formed of plastics material, and typically having an axial clearance of around 0.25 mm. It may be that the restrictor is a sealable restrictor, for example a sealable restrictor which allows flow in a single direction only. For example, it may be that the sealable restrictor takes the form of a resilient flap which provides a seal but which, under the influence of a pressure differential with higher pressure on the side in communication with the volume including the bearings, lifts to allow the flow of oil out of the volume including the bearings. Thus, oil flows in only one direction, from the low temperature oil flow, towards the low pressure line. The restrictor reduces ingress of swarf, debris and contamination into the bearings.

It may be that the reduced temperature oil feed is configured to direct oil through the or each respective bearing into a crank case surrounding the working chambers of cyclically varying volume.

Oil from the oil circuit and oil from the reduced temperature oil feed may mix within the hydraulic pump and/or within the hydraulic motor.

Typically, oil from the reduced temperature oil feed eventually mixes with oil received by the working chamber from the oil circuit, after lubricating the bearings. The mixed oil is typically directed to a low pressure line for reuse.

The hydraulic pump and/or the hydraulic motor respectively may comprise a crank case enclosing the cam and pistons, wherein the oil from the oil circuit and oil from the reduced temperature oil feed mix within the crank case.

Typically, there is at least some leakage of oil from the working chambers into the crank case. Oil from the reduced temperature oil feed passes through the bearings into the crank case. Therefore, these two sources of oil mix in the crank case. Typically, oil in the crank case is at a temperature intermediate the temperature of the oil introduced to the bearings by the reduced temperature oil feed and the oil received by the working chambers of the hydraulic pump and/or hydraulic motor, as appropriate. Typically, less than 5% of the oil received by the working chambers of the hydraulic pump and/or hydraulic motor mixes with the oil from the reduced temperature oil feed (typically after passing into the crank case).

The hydraulic pump and/or hydraulic motor may further comprise a drain in fluid communication with the crank case, through which oil from both the oil circuit and the reduced temperature oil feed is removed.

Typically the flow rate of oil through the reduced temperature oil feed to the bearings of the hydraulic pump and/or the hydraulic motor is less than one tenth or more preferably less than one twentieth or less than one fiftieth of the maximum operating rate of receipt of oil from the oil circuit by the hydraulic pump or hydraulic motor, respectively.

The temperature of the oil received from the oil circuit by the working chambers of the hydraulic pump and the hydraulic motor is typically in the range of 5 to 70° C., and normally in the range 30 to 60° C. The oil supplied to the bearing through the reduced temperature oil feed may preferably be in the range of 20 to 40° C.

The hydraulic pump may be operable only as a pump. However, the hydraulic pump may be a pump-motor which is operable as a pump or as a motor in alternative operating modes. Similarly, the hydraulic motor may be operable only as a motor. However, the hydraulic motor may be a pump-motor which is operable as a pump or as a motor in alternative operating modes. Machines capable of functioning as either a pump or a motor in alternative operating modes are disclosed in EP 0494236, for example.

The renewable energy turbine generator may be a wind turbine generator and the rotor may comprise a plurality of blades.

According to a second aspect of the invention there is provided a method of supplying oil to a hydraulic pump and/or hydraulic motor of a renewable energy turbine generator,
the renewable energy turbine comprising:
a rotor, a generator and a hydraulic transmission which transmits rotational energy from the rotor to the generator,
the hydraulic transmission comprising a variable displacement hydraulic pump which is driven by the rotor, a variable displacement hydraulic motor which is coupled to the generator, and an oil circuit comprising a high pressure oil line which is arranged between a discharge side of the hydraulic pump and an intake side of the hydraulic motor, and a low pressure line which is arranged between an intake side of the hydraulic pump and a discharge side of the hydraulic motor,
each of the hydraulic pump and the hydraulic motor comprising: a plurality of working chambers each of which is defined by a cylinder and a piston slidably mounted in the cylinder, a rotatable shaft couple to a cam, the cam having a cam surface in engagement with the said pistons, the cycles of working chamber volume being coupled to rotation of the rotatable shaft, bearings in engagement with the rotatable shaft, and a plurality of valves for regulating the net displacement of working fluid between each working chamber and the high and low pressure lines, at least one valve associated with each working chamber being an electronically controlled valve, said electronically controlled valves being operable by the controller to select the volume of working fluid displaced by each said working chamber on each cycle of working chamber volume and thereby regulate the net rate of displacement of working fluid by the hydraulic pump and the hydraulic motor respectively,
wherein the method comprises introducing oil to the bearings of the hydraulic pump and/or the hydraulic motor at a lower temperature than the oil supplied from the oil circuit to the working chambers of the hydraulic pump and/or hydraulic motor respectively.

The method may comprise filtering the oil introduced to the bearings through a finer filter than oil in the oil circuit.

It may be that the hydraulic pump and/or the hydraulic motor comprise a crank case and the oil introduced to the bearings and oil in the oil circuit mix in the crank case.

Further optional features of the method of the second aspect correspond to features discussed above in relation to the first aspect of the invention.

### BRIEF DESCRIPTION OF DRAWINGS

FIG. 1 is a schematic diagram of a wind turbine generator illustrating feeds for supplying oil;

FIG. 2 is a schematic diagram of a cross-section through a hydraulic pump; and

FIG. 3 is a schematic cross section through a hydraulic motor illustrating a cooled and filtered feed of oil to the bearings.

### DESCRIPTION OF EMBODIMENTS

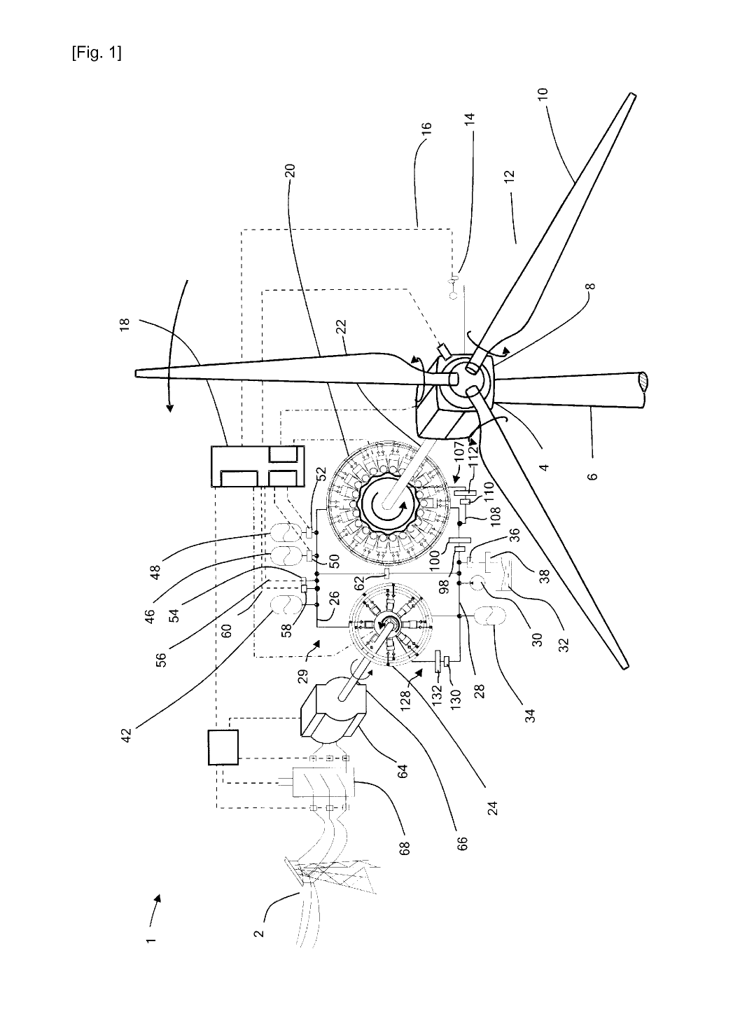

FIG. 1 illustrates an example embodiment of the invention in the form of a Wind Turbine Generator (WTG) 1, acting as the renewable energy turbine device, and connected to an electricity network 2. The WTG comprises a nacelle 4 rotatably mounted to a tower 6 and having mounted thereon a hub 8 supporting three blades 10 known collectively as the rotor 12. An anemometer 14 attached externally to the nacelle provides a measured wind speed signal 16 to a controller 18.

The hub is connected directly to a hydraulic pump 20, through a drive shaft 22. The pump is a variable displacement radial piston pump of the type in which the volume of hydraulic oil displaced by each cylinder during each cycle of cylinder volume is selectable through the control of electronic valves. The discharge side of the pump is connected to the intake side of a hydraulic motor 24, which is a variable displacement radial piston motor of the type in which the volume of hydraulic oil displaced by each cylinder during each cycle of cylinder volume is selectable through the control of electronic valves. The fluid connection between the discharge side of the pump and the intake side of the hydraulic motor is through a high pressure oil line 26 and a low pressure oil line 28 extends from a discharge side of the motor to an intake side of the pump. The high pressure oil line and low pressure oil line are each part of an oil circuit shown generally as 29.

A charge pump 30 continuously draws fluid from a reservoir 32 into the low pressure oil line, which is connected to a low pressure accumulator 34. A pressure relief valve 36 returns fluid from the low pressure oil line to the reservoir through a filter 38. A smoothing accumulator 42 is connected to the high pressure oil line between the pump and the hydraulic motor. A first high pressure accumulator 46 and a second high pressure accumulator 48 are connected to the high pressure oil line through a first isolating valve 50 and a second isolating valve 52 respectively.

Filter 100 and cooler 98 may be installed directly in the hydraulic circuit (as shown in FIG. 1) or in a bypass loop (not shown). When incorporated in a bypass loop, a check valve (with a lift setting of 0.5 bar, for example) is located in the bypassed part of the main circuit. The bypass loop has a smaller diameter bore than the bypassed part of the main circuit. Thus, the relative proportion of the total flow of oil which passes through the filter and cooler, and the proportion which continues through the bypassed part of main circuit are controlled. In some embodiments, all of the circulating oil passes through the filter and cooler unless the flow rate exceeds a threshold in which case some oil continues through the bypassed part of the circuit. The threshold may be close to the maximum flow rate which in some examples is around 5,000 litres per minute. The temperature in the high pressure oil line is measured with a temperature sensor 54, which provides the controller with high pressure oil line temperature signal 56. A pressure sensor 58 measures the pressure in the high pressure oil line and transmits a high pressure oil line pressure signal 60 to the controller. A high pressure relief valve 62 connects the high pressure and low pressure oil lines.

The hydraulic motor is connected to a generator 64, through a generator shaft 66. The generator is connected to an electricity network through a contactor 68, which is under the control of a contactor controller 70 and is operable to selectively connect the generator to or isolate the generator from the electricity network.

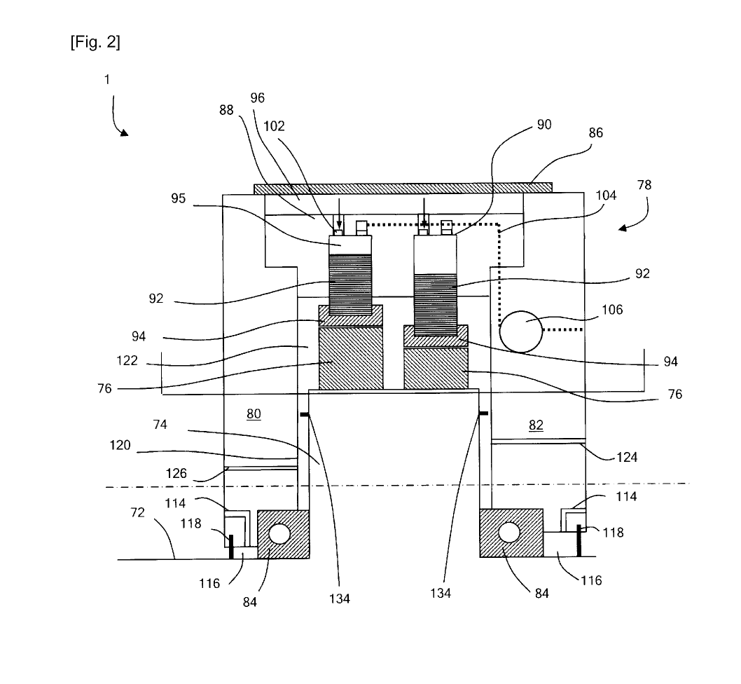

With reference to FIG. 2, the pump comprises a pump shaft 72 which is integral with or in driving connection with drive shaft 22. The pump shaft is connected to a cam support 74 which supports multi-lobal cams 76. The pump has an outward ring 78 comprising axially spaced first and second end plates 80, 82 which are independently mounted on the pump shaft through bearings 84. The pump is generally rotationally symmetric about an axis extending through the drive shaft and has a removable cover 86. Demountable cylinder blocks 88 are circumferentially distributed around the pump and define cylinders 90 within which pistons 92 are slidably retained in driving engagement with the cams through piston rollers 94. The volume defined between the cylinders and their respective pistons functions as a working chamber 95 of cyclically varying volume. A low pressure gallery 96 extends around the periphery of the cylinders, underneath the cover. The pressure of hydraulic oil in the low pressure gallery in use is low relative to pressure in the high pressure oil manifold, but may in practice be pressurised to some extent, for example to around 5 bar to facilitate the flow of oil into the cylinders.

With reference to FIGS. 1 and 2, low pressure hydraulic oil is supplied to the working chambers by the following path. A primary temperature regulator 98, functioning as the second temperature regulator, receives hydraulic oil from the low pressure oil line through a first oil receiving inlet 99, usually at a temperature of 40 to 60° C. during normal operation and cools it. At this cooled temperature, the viscosity of the oil is lowered and suitable for efficient use in the working chambers of the pump. In some embodiments, the primary temperature regulator functions only as a cooler. In other embodiments, the primary temperature regulator may warm the hydraulic oil in some circumstances, for example, on start up in cold conditions. The resulting filtered, temperature regulated oil is fed through a primary filter 100, functioning as a first filter, and is then supplied to the low pressure gallery where it is supplied to the working chambers through electronically controlled valves 102. This input functions as the intake side of the hydraulic pump.

Oil which is displaced by the working chambers is output through a high pressure oil manifold 104 and through a conduit 106 to the high pressure oil line. The output from the conduit functions as the discharge side of the hydraulic pump.

The pump further includes a reduced temperature oil feed 107 which introduces oil to the bearings. The reduced temperature oil feed includes an oil receiving inlet 108 which receives oil, downstream of the primary filter. The amount of oil received may, for example, be less than 5% of the oil which passes into the working chambers at maximum flow rate. The received oil is cooled further, typically to around 20-40° C. by a supplementary temperature regulator 110 (functioning as the first temperature regulator). The supplementary temperature regulator is typically a refrigerator. The further cooled oil is passed through a supplementary filter 112, functioning as the first filter, which is finer than the first filter and therefore filters the oil to an increasing level of purity. For example the supplementary filter may have a mesh size of 3 microns where the first filter has a mesh size of 10 microns. The oil passed through the supplementary filter is then supplied through an input line 114 into a space 116 defined between a set of bearings and a shaft seal 118. Thus, oil is supplied to the bearing at a lower temperature than oil is supplied to the working chambers. The oil supplied to the bearing is therefore more viscous, which is preferable for both the performance of and lifetime of the bearings.

The pump has a crank case 120, including the oil filled space around the ring cam 122, part of the pump shaft and the piston rollers. In a first example embodiment, oil from low pressure oil line is also supplied through crankshaft supply conduit 124 to the crank case. The oil drains away to the low pressure oil line through a drain 126. The restrictor allows slow leakage of oil and thus there is mixing of oil from the reduced temperature feed and oil supplied directly from the supplementary filter which takes place in the crank case.

In a second example embodiment, the oil supplied through the conduit 124 to the crank case is oil from the reduced temperature feed, which has been cooled by the supplementary temperature regulator and filtered by the supplementary filter. This can be preferable in some embodiments where it is desired to have relatively high viscosity oil in the crank case.

In a third example embodiment, the oil supplied through the conduit 124 to the crank case is at a third temperature, regulated by a third temperature regulator, for example a temperature intermediate the temperature at which oil is supplied to the low pressure gallery and the temperature at which oil is supplied to the bearing.

With reference to FIG. 1, reduced temperature oil is also supplied to the bearings of the motor. A further temperature regulator 130 (also functioning as a first temperature regulator) receives oil from the low pressure line and cools it to around 20-40° C. The temperature of oil in the high pressure oil line is typically lower than the temperature of oil in the low pressure oil line because the hydraulic motor reduces pressure and the oil flow is accelerated. The accelerated flow of oil results in friction, and so temperature is increased. The reduced temperature oil is fed through a further supplementary filter 132 to the bearing of the motor in a similar way to the reduced temperature oil supplied to the pump. In an alternative embodiment, oil cooled by the second temperature regulator (and typically also filtered by the second filter) is supplied to the bearings of both the pump and the motor.

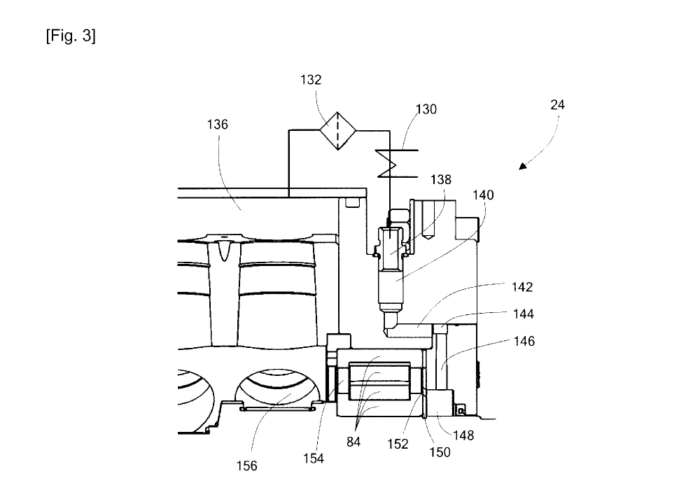

FIG. 3 provides further detail of the supply of reduced temperature oil feed to a hydraulic motor. Oil received from a low pressure gallery 136 is supplied through filter 132 and cooler 130 to a hydraulic connection 138. It passes through a radial drillway 140 and axial drillway 142, through an annulus 144 and a further radial drillway 146 to an annular space 148. A shim 150 includes one or more apertures 152 through which oil passes gradually from the annular space into the bearings 84, which are flooded with the reduced temperature oil. Once the oil has passed through the bearings it passes through an aperture 154 into the crankcase 156.

Further variations and modifications may be made within the scope of the invention herein disclosed.

### REFERENCE SIGNS LIST

1 Wind turbine generator (WTG)
2 Electricity network
4 Nacelle
6 Tower
8 Hub
10 Blades
12 Rotor
14 Anemometer
16 Wind speed signal
18 Controller
20 Hydraulic pump
22 Drive shaft
24 Hydraulic motor
26 High pressure oil line
28 Low pressure oil line
30 Oil circuit
32 Charge pump
34 Reservoir
36 Low pressure accumulator
38 Pressure relief valve
40 Filter
42 Accumulator
46 First high pressure accumulator
48 Second high pressure accumulator
50 First isolating valve
52 Second isolating valve
54 Temperature sensor
56 Temperature signal
58 Pressure sensor
60 Pressure signal
62 Relief valve
64 Generator
66 Generator shaft
68 Contactor
70 Contactor controller
72 Pump shaft
74 Cam support
76 Cams
78 Outward ring
80 First end plate
82 Second end plate
84 Bearings
86 Cover
88 Cylinder blocks
90 Cylinders
92 Pistons
94 Piston rollers
95 Working chambers
96 Low pressure gallery
98 Primary temperature regulator
99 First oil receiving inlet
100 Primary filter
102 Electronically controlled valves
104 High pressure oil manifold
106 Conduit
107 Reduced temperature oil feed
108 Oil receiving inlet
110 Supplementary temperature regulator
112 Supplementary filter
114 Input line
116 Space
118 Shaft seal
120 Crank case
122 Ring cam
124 Crankshaft supply conduit
126 Drain
128 Further reduced temperature oil feed
130 Further temperature regulator
132 Further supplementary filter
134 Restrictor ring
136 Low pressure gallery
138 Hydraulic connection
140 Radial drillway
142 Axial drillway
144 Annulus
146 Further radial drillway
148 Annular space
150 Shim
152 Aperture
154 Aperture
156 Crankcase

1. A renewable energy turbine generator comprising:
a rotor, a generator and a hydraulic transmission which transmits rotational energy from the rotor to the generator,
the hydraulic transmission comprising a variable displacement hydraulic pump which is driven by the rotor, a variable displacement hydraulic motor which is coupled to the generator, and an oil circuit comprising a high pressure oil line which is arranged between a discharge side of the hydraulic pump and an intake side of the hydraulic motor, and a low pressure line which is arranged between an intake side of the hydraulic pump and a discharge side of the hydraulic motor,
each of the hydraulic pump and the hydraulic motor comprising: a plurality of working chambers each of which is defined by a cylinder and a piston slidably mounted in the cylinder, a rotatable shaft coupled to a cam, the cam having a cam surface in engagement with the said pistons, the cycles of working chamber volume being coupled to rotation of the rotatable shaft, bearings in engagement with the rotatable shaft, and a plurality of valves for regulating the net displacement of working fluid between each working chamber and the high and low pressure lines, at least one valve associated with each working chamber being an electronically controlled valve, said electronically controlled valves being operable by the controller to select the volume of working fluid displaced by each said working chamber on each cycle of working chamber volume and thereby regulate the net rate of displacement of working fluid by the hydraulic pump and the hydraulic motor respectively,
wherein the hydraulic pump and/or the hydraulic motor comprise a reduced temperature oil feed configured to introduce oil to the bearings, wherein the renewable energy turbine generator comprises at least one first temperature regulator for regulating the temperature of oil to the reduced temperature oil feed such that the oil supplied by the reduced temperature oil feed is cooler than the oil supplied from the oil circuit to the working chambers of the hydraulic pump and/or hydraulic motor respectively.

2. A renewable energy turbine generator according to claim 1, wherein the reduced temperature oil feeds are in fluid communication with the oil circuit to receive oil from the oil circuit and to regulate the temperature of the received oil before it is introduced to the bearings.

3. A renewable energy turbine generator according to claim 2, wherein the or each reduced temperature oil feed is in fluid communication with the low pressure line.

4. A renewable energy turbine generator according to claim 2, comprising at least one first filter arranged to filter at least a proportion of oil circulating in the oil and at least one second filter interposed in the reduced temperature oil feeds to filter oil before it is introduced to the bearings, wherein the at least one second filter is finer than the at least one first filter.

5. A renewable energy turbine generator according to claim 1, further comprising at least one second temperature regulator to regulate the temperature of oil in the oil circuit.

6. A renewable energy turbine generator according to claim 1, wherein the hydraulic pump and/or the hydraulic motor respectively comprises a restrictor around the respective rotating shaft which in part defines and retains oil within a volume including the bearings, wherein the reduced temperature oil feed is in fluid communication with the volume including the bearings.

7. A renewable energy turbine generator according to claim 1, wherein oil from the oil circuit and oil from the reduced temperature oil feed mix within the hydraulic pump and/or within the hydraulic motor.

8. A renewable energy turbine generator according to claim 7, wherein the hydraulic pump and/or the hydraulic motor comprise a crank case enclosing the cam and pistons, wherein the oil from the oil circuit and oil from the reduced temperature oil feed mix within the crank case.

9. A renewable energy turbine generator according to claim 7, wherein the temperature between the oil supplied to the bearings of the hydraulic pump and/or the hydraulic motor is at most 40° C. less than the temperature of the oil received from the oil circuit by the working chambers of the hydraulic pump and/or the hydraulic motor respectively.

10. A renewable energy turbine generator according to claim 1, wherein the renewable energy turbine generator is a wind turbine generator and the rotor comprises a plurality of blades.

11. A method of supplying oil to a hydraulic pump and/or hydraulic motor of a renewable energy turbine generator, the renewable energy turbine comprising:
a rotor, a generator and a hydraulic transmission which transmits rotational energy from the rotor to the generator,
the hydraulic transmission comprising a variable displacement hydraulic pump which is driven by the rotor, a variable displacement hydraulic motor which is coupled to the generator, and an oil circuit comprising a high pressure oil line which is arranged between a discharge side of the hydraulic pump and an intake side of the hydraulic motor, and a low pressure line which is arranged between an intake side of the hydraulic pump and a discharge side of the hydraulic motor,
each of the hydraulic pump and the hydraulic motor comprising: a plurality of working chambers each of which is defined by a cylinder and a piston slidably mounted in the cylinder, a rotatable shaft couple to a cam, the cam having a cam surface in engagement with the said pistons, the cycles of working chamber volume being coupled to rotation of the rotatable shaft, bearings in engagement with the rotatable shaft, and a plurality of valves for regulating the net displacement of working fluid between each working chamber and the high and low pressure lines, at least one valve associated with each working chamber being an electronically controlled valve, said electronically controlled valves being operable by the controller to select the volume of working fluid displaced by each said working chamber on each cycle of working chamber volume and thereby regulate the net rate of displacement of working fluid by the hydraulic pump and the hydraulic motor respectively,
wherein the method comprises introducing oil to the bearings of the hydraulic pump and/or the hydraulic motor at a lower temperature than the oil supplied from the oil circuit to the working chambers of the hydraulic pump and/or hydraulic motor respectively.

12. A method according to claim 11, wherein the method comprises filtering the oil introduced to the bearings through a finer filter than oil in the oil circuit.
